(19) United States
(12) Patent Application Publication
(10) Pub. No.: US 2022/0391859 A1
(43) Pub. Date: Dec. 8, 2022

(54) SECURE CRYPTOCURRENCY TRANSACTION WITH IDENTIFICATION INFORMATION

(71) Applicant: Vesto LLC, (US)

(72) Inventors: Christopher McGregor, Cheyenne, WY (US); Travis M. McGregor, Greenbrae, CA (US); Wolfgang Decker, Gruenwald (DE); Carsten Bartsch, Munich (DE)

(73) Assignee: Vesto LLC

(21) Appl. No.: 17/341,452

(22) Filed: Jun. 8, 2021

(51) Int. Cl. G06Q 20/06; G06Q 20/38

(52) U.S. Cl. CPC G06Q 20/065; G06Q 20/389; G06Q 20/3827; G06Q 20/3829; G06Q 2220/00

(57) ABSTRACT

A system and method for secure cryptocurrency transactions with identification information includes a server arrangement communicably coupled to a distributed ledger-based platform, where the server arrangement adds information related to the transaction in the metadata of the transaction. This allows for the availability of information regarding the transaction and also track the transaction, the senders and the receivers of the transaction, if need be. Further, the system may include an additional aspect of an approving authority signing and approving a transaction based on the authenticity of the sender and receiver information, associated with the cryptocurrency transaction.

### FIELD OF THE DISCLOSURE

The present application relates generally to the field of cryptocurrency transactions on distributed ledger platforms. More particularly, the present disclosure pertains to use of identification information for distributed ledger cryptocurrency transactions.

### BACKGROUND OF THE DISCLOSURE

The cryptographic technologies used in cryptocurrency have created the concept of truth in a public ledger. The data of the cryptocurrency transactions is immutable and the sender may be verified without revealing the identity of an individual or entity, since the private key used for verification is held privately. Even though privacy is a benefit, it has also been a major cause of concern due to the ability to use cryptocurrencies for money laundering and other illegal purposes. This is the main reasons that the governments, banks, authorities and other institutions have been reluctant to adopt cryptocurrency.

In an effort to combat money laundering and add ‘Know Your Customer, (KYC), major crypto exchanges like Coinbase have required customers to provide all relevant documents and information to open an account, similar to opening a traditional bank account. Even though this appears to be a great solution to combat problems such as money laundering, it does not solve it. In the current available systems, anyone providing the relevant documents and information may open an account and transfer fiat currency from their bank account and buy cryptocurrency which would be held in a custodial wallet. At this point, individual or entity could create a non-custodial wallet (private and public keys held privately) and transfer the cryptocurrency from the newly created crypto exchange's custodial wallet into it. Subsequently, the transactions could become untraceable and the identity of the sender and/or the recipient would be unknown.

In view of the above, there exists a need to provide a solution to the technical problems associated with distributed ledger-based platform.

### SUMMARY OF THE DISCLOSURE

Embodiments of the present disclosure present technological improvements on cryptographic transactions on blockchains as solutions to one or more of the above-mentioned technical problems.

An object of the present disclosure is to secure cryptocurrency transaction with identification information on a blockchain.

The present disclosure discloses a system and a method for facilitating secure cryptocurrency transactions with identification information on a blockchain. In one embodiment of the present disclosure, the system and method may include a server arrangement communicably coupled to a distributed ledger-based platform, wherein the server arrangement may be configured to add identification information related to the transaction in the metadata of the transaction. This identification information may help to track the transaction, the identity of senders and the receivers of the transaction, if needed.

The server arrangement is configured to receive a transaction request, to identify whether the sender and the receiver have been approved, to add identification information to the metadata of the transaction, to add signature (i.e., private key) of the approving authority to it, and to execute the transaction. Further, the disclosure also includes an additional aspect of an approving authority signing and approving a transaction made between the sender and receiver. This adds an additional layer of authenticity to the transaction.

Disclosed herein is a system for facilitating secure cryptocurrency transaction with identification information. The system may include a server arrangement communicably coupled via a communication network with one or more sender devices and one or more receiver devices. The server arrangement may be configured to receive one or more transaction requests for one or more transactions from the one or more sender devices. The one or more transaction requests may include at least a unique identifier of one or more senders using the corresponding sending devices; a unique identifier of one or more receivers using the corresponding receiving devices; and one or more applicable rules for the transaction. The server arrangement may be further configured to identify one or more public IDs of the one or more senders and one or more public IDs the one or more receivers from a memory device communicably coupled with the server arrangement; identify whether or not, the one or more senders and the one or more receivers are approved by an approving authority. Based on the successful identification of the one or more senders and the one or more receivers as an approved, the server arrangement is further configured to create at least one metadata for each of the one or more transactions. The at least one metadata may include at least a unique identifier of the at least one metadata; the one or more public IDs of one or more approved senders; the one or more public IDs of one or more approved receivers; and a unique identifier of the approving authority. The server arrangement may be further configured to create at least one hash of the at least one metadata; create at least one approved transaction token for the at least one hash of the at least one metadata wherein the at least one approved transaction token comprises the at least one hash of the at least one metadata and a private key of the approving authority; transfer the one or more transaction requests along with the at least one approved transaction token to a distributed ledger-based platform; and execute the one or more transactions using the distributed ledger-based platform.

In one embodiment, the server arrangement is further configured to send the at least one approved transaction token to the one or more sender devices.

In one embodiment, the one or more sender devices is configured to hash the received at least one approved transaction token, sign it using one or more private keys of the one or more senders and transfer the one or more transaction requests along with the hashed and signed at least one approved transaction token to a distributed ledger-based platform.

In one embodiment, the server arrangement is configured to facilitate, via an associated device, the approving authority to: receive from the one or more senders and the one or more receivers, one or more KYC documents of the one or more senders and the one or more receivers respectively; verify if the received one or more KYC documents complies with at least one predefined authenticity criterion; approve the one or more senders and the one or more receivers, in the event the received one or more KYC documents complies with at least one predefined authenticity criterion; and deny approval to the one or more senders and the one or more receivers, in the event the received one or more KYC documents fails to comply with the at least one predefined authenticity criterion.

In one embodiment, the at least one approved transaction token is used to verify the authenticity of the one or more transactions, the one or more senders and the one or more receivers.

In one embodiment, the at least one metadata for each of the one or more transactions comprises one or more of a type of cryptocurrency to be used, a crypto exchange to be used for the transaction, one or more transaction amounts for each of the one or more transactions, a location of the one or more senders and the one or more receivers, a contact information of the one or more senders and the one or more receivers, crypto exchange rate.

In one embodiment, the transaction request and the at least one approved transaction token are added as a new block on the blockchain.

In one embodiment, the one or more transactions are executed using one or more smart contracts.

In yet another aspect, an embodiment provides a computer readable medium includes program instructions for execution on a computer system, which when executed by a computer, cause the computer to perform a method for facilitating cryptocurrency transaction. The method may be processed using a server arrangement. The method may include: receiving one or more transaction requests for one or more transactions from the one or more sender devices. The one or more transaction requests may include at least a unique identifier of one or more senders using the corresponding sending devices; a unique identifier of one or more receivers using the corresponding receiving devices; and one or more applicable rules for the transaction. The method further includes: identifying one or more public IDs of the one or more senders and one or more public IDs the one or more receivers from a memory device communicably coupled with the server arrangement; identifying whether the one or more senders and the one or more receivers are approved by an approving authority. Based on the successful identification of the one or more senders and the one or more receivers as an approved, creating at least one metadata for each of the one or more transactions. The at least one metadata may include at least a unique identifier of the at least one metadata; the one or more public IDs of one or more approved senders; the one or more public IDs of one or more approved receivers; and a unique identifier of the approving authority. The method may further include: creating at least one hash of the at least one metadata; creating at least one approved transaction token for the at least one hash of the at least one metadata wherein the at least one approved transaction token comprises the at least one hash of the at least one metadata and a private key of the approving authority; transferring the one or more transaction requests along with the at least one approved transaction token to a distributed ledger-based platform; and executing the one or more transactions using the distributed ledger-based platform.

Additional aspects, features and advantages of the present disclosure would be made apparent from the drawings and the detailed description of the illustrative embodiments construed in conjunction with the appended claims that follow. The systems and methods illustrated are equally applicable to virtually any communication device, including but not limited for example, computers and mobile phones.

It will be appreciated that features of the present disclosure are susceptible to being combined in various combinations without departing from the scope of the present disclosure as defined by the appended claims. Additional aspects, advantages, features and objects of the present disclosure would be made apparent from the drawings and the detailed description of the illustrative embodiments construed in conjunction with the appended claims that follow.

### BRIEF DESCRIPTION OF DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of the system for facilitating secure cryptocurrency transaction with identification information.

FIG. 2 is a schematic illustration of an approved transaction token.

FIGS. 3A and 3B show illustrations of steps and methods for facilitating cryptocurrency transaction.

FIG. 4 is an illustration of steps and methods for approving a user.

### DETAILED DESCRIPTION OF THE EMBODIMENTS

Embodiments of the present disclosure present technological improvements as solutions to one or more technical problems recognized by the inventor in conventional systems. The following detailed description illustrates embodiments of the present disclosure and ways in which they may be implemented. Although some modes of carrying out the present disclosure have been disclosed, those skilled in the art would recognize that other embodiments for carrying out or practicing the present disclosure are also possible.

The subject disclosure describes, among other things, illustrative embodiments for a distributed ledger-based system and method, wherein detailed information of cryptocurrency transactions are identified and approved by an approving authority. The primary embodiment of the present invention discloses a system and a method for facilitating secure cryptocurrency transaction with identification information and also encompasses its various models and computer—aided interaction systems.

Throughout the disclosure, one or more components are described as unit for understanding of the specification. For example, a unit may include self-contained component in a hardware circuit comprising of logical gate, semiconductor device, integrated circuits or any other discrete component. The unit may also be a part of any software program executed by any hardware entity for example processor. The implementation of unit as a software programme may include a set of logical instructions to be executed by a processor or any other hardware entity.

Additional or less units may be included without deviating from the disclosure. In addition, each unit may include any number and combination of sub-units, and systems, implemented with any combination of hardware and/or software units. Method steps may be performed by one or more computer processors executing a program tangibly embodied on a computer-readable medium to perform functions by operating on input and generating output.

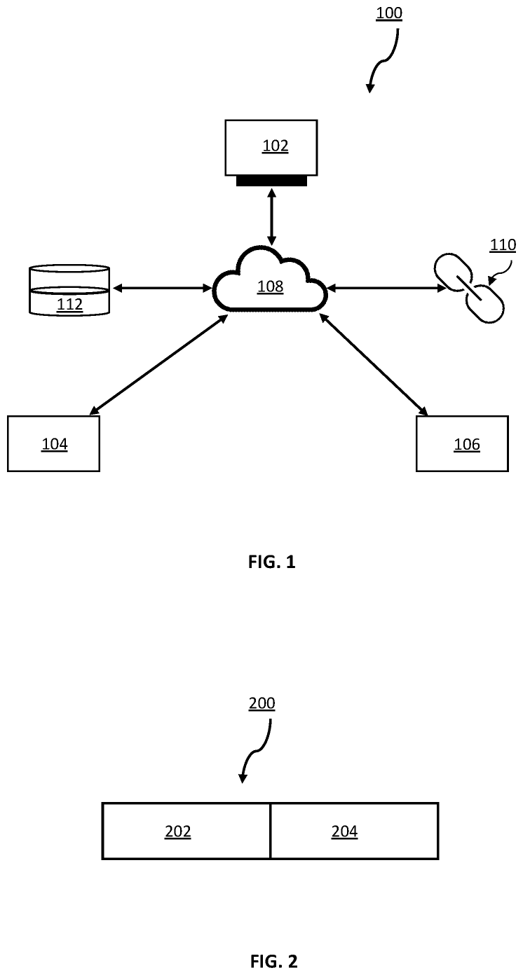

FIG. 1 depicts an exemplary system 100 including a server arrangement 102 communicably coupled via a communication network 108 with a sender device 104, a receiver device 106, a distributed ledger-based platform 110, and a memory device 112.

The server arrangement 102 is configured to receive one or more transaction requests for one or more transactions from the one or more sender devices 104. The sender devices 104 may have a processor, a graphical user interface (GUI), and a memory for storing the data pertaining to the cryptocurrency transactions. The sender devices may also be configured to download and execute one or more computer applications to be executed for carrying out the processes mentioned herein. Each transaction request initiated by a sender device 104 may include information related to the requested transaction such as a unique identifier of the sender, a unique identifier of the receiver and applicable rules for the transaction. The applicable rules may be predefined and stored in the memory device 112 or any external storage device or a database that is communicably coupled to the server arrangement 102. For example, the applicable rules may include decentralized finance (DeFi) protocols to manage the transactions of the decentralized and distributed ledgers. The server arrangement 102 is further configured to identify a public ID of the sender and a public ID of the receiver from the memory device 112. Further, the server arrangement 102 may be configured to identify whether the senders and the receivers are approved by an approving authority. The approving authority may verify whether or not the sender and receiver have complied to the protocols laid by the approving authority. For example, the approving authority may examine the if the sender and receiver have complied to the KYC (know your customer) protocol. For approved senders and receivers, the server arrangement 102 is further configured to create a metadata for each of the transactions. The metadata comprises a unique identifier of the metadata, the public ID of the approved sender, the public ID of the approved receiver and a unique identifier of the approving authority. Furthermore, the server arrangement 102 is also configured to create a one hash of the metadata and then an approved transaction token for the hash of the metadata. The server arrangement 102 is operable to transfer the one or more transaction requests along with an approved transaction token for each of the transaction requests to a distributed ledger-based platform 110 and execute the transactions using the distributed ledger-based platform 110.

In the primary embodiment of the present disclosure, the core of the entire system is the server arrangement 102 that is configured to facilitate the cryptocurrency transaction. Throughout the present disclosure, the term “server arrangement” refers to an arrangement of one or more servers that includes one or more processors and databases configured to perform various operations. Additionally, the server arrangement 102 may include any arrangement of physical or virtual computational entities capable of performing the various operations.

Moreover, it will be appreciated that the server arrangement 102 may be implemented by way of a single hardware server. The server arrangement 102 may alternatively be implemented by way of a plurality of hardware servers operating in a parallel or distributed architecture. As an example, the server arrangement 102 may include components such as a memory unit, a processor, a network adapter and the like, to store and process information pertaining to the document and to communicate the processed information to other computing components, for example, such as a sender device 104. Furthermore, the server arrangement 102 comprises one or more memory devices for storing data therein. Throughout the present disclosure, the term “server” generally refers to a device executing an application, program, or process in a client/server relationship that responds to requests for information or services by another application, program, process or device (namely, a client) on a data communication network.

The term “processor” may refer to one or more individual processors, processing devices and various elements associated with a processing device that may be shared by other processing devices. Additionally, the one or more individual processors, processing devices and elements are arranged in various architectures for responding to and processing the instructions that drive the aforesaid system. Suitable processors include, by way of example, both general and special purpose microprocessors. Generally, the processor receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer may generally also receive (read) programs and data from, and write (store) programs and data to, a non-transitory computer-readable storage medium such as an internal disk (not shown) or a removable disk.

The terms “sender device” and “receiver device” may refer to electronic devices executing an application, program, or process, the devices associated with (or used by) a user (namely, a sender and a receiver), that are capable of enabling the user to perform specific tasks associated with the aforementioned system/method. Furthermore, the sender device 104 and the receiver device 106 are intended to be broadly interpreted to include any electronic device that may be used for cryptocurrency transactions, such as mobile phones and computers.

In one embodiment, the one or more transaction requests for one or more transactions from the one or more sender devices 104 comprises at least a unique identifier of one or more senders, a unique identifier of one or more receivers, and one or more applicable rules for the transaction. The unique identifier of the one or more sender and the one or more receiver is at least a user id, mobile number, email id. The rules of the transaction may be one or more of transferring a certain amount of cryptocurrency from a virtual wallet associated with the sender to a virtual wallet associated with the receiver. Additionally, the rules may have one or more conditions that needs to be satisfied before the transaction is executed, such as KYC. In this embodiment, the server arrangement 102 may detect the successful satisfaction of the one or more conditions and then executes the transaction.

Further, the system may identify whether the one or more senders and the one or more receivers are approved by an approving authority. The server arrangement 102 cross checks whether the one or more senders and the one or more receivers have completed the process of getting an approval from the approving authority. For illustrative purposes, an approving authority may be one of a bank, a government body, a cryptocurrency exchange or an organisation set up for verifying cryptocurrency transactions. In some embodiments, the server arrangement 102 may be owned by the approving authority. In some other embodiments, the server arrangement 102 and the approving authority belong to the same entity.

In an additional embodiment, the server arrangement 102 may be configured to facilitate the approving authority to receive from the one or more senders and the one or more receivers, one or more KYC documents of the one or more senders and the one or more receivers. The one or more KYC documents may then be verified for authenticity. Upon successful verification, the one or more senders and the one or more receivers are approved.

The server arrangement 102 may further be configured to facilitate the approving authority to approve or deny the sender and receiver for making a transaction, the approving authority may use at least one associated device, configured to receive the KYC documents and provide or deny an approval to the sender and the receiver. The associated device of the approving authority may receive from the one or more senders and the one or more receivers, the one or more KYC documents of the one or more senders and the one or more receivers respectively. The approving authority may verify if the received one or more KYC documents complies with at least one predefined authenticity criterion. The authenticity criteria may be predefined and used for the verification purposes by appropriate authority, such as government, bank officials, institutional heads etc. In the event the received one or more KYC documents complies with at least one predefined authenticity criterion, the approving authority approves the one or more senders and the one or more receivers for making the cryptocurrency transactions. On the other hand, an approval may be denied by the approving authority in case the received one or more KYC documents fails to comply with the at least one predefined authenticity criterion.

In one embodiment, the server management blocks or seals the cryptocurrency transaction in the event the one or more senders and the one or more receivers are not approved by the approving authority. The sealing of the cryptocurrency transactions may be a temporary sealing or blocking process until the investigation or verification process of the approving authority is pending. Once the sender and the receiver are identified to have complied the applicable rules, the approving authority provides with the approval, and subsequently the cryptocurrency transactions are allowed.

In alternate embodiments, the metadata of a transaction consists of, but not limited to, the following attributes: a unique identifier of the metadata; the type of the metadata, (for example, whether the metadata is related to purchase, payment, income, etc.); the name of the crypto exchange to be used; type of cryptocurrency of the transaction; the public ID of the sender; the public ID of the recipient; applicable taxes if any; any fees associated with the transaction; details of the approving authority, such as name and a public key of the approving authority; private key of the approving authority; nonce—unique or sequential value that forces the metadata hash to be unique; the location of the sender and the receiver; encrypted signature.

The metadata may be hashed to ensure that it is not misused and/or modified. The system may use one or more types of hash functions to hash the metadata. In an exemplary example, without limiting the scope of the disclosure, the hash functions used are SHA-256 and 32-byte Keccak hash.

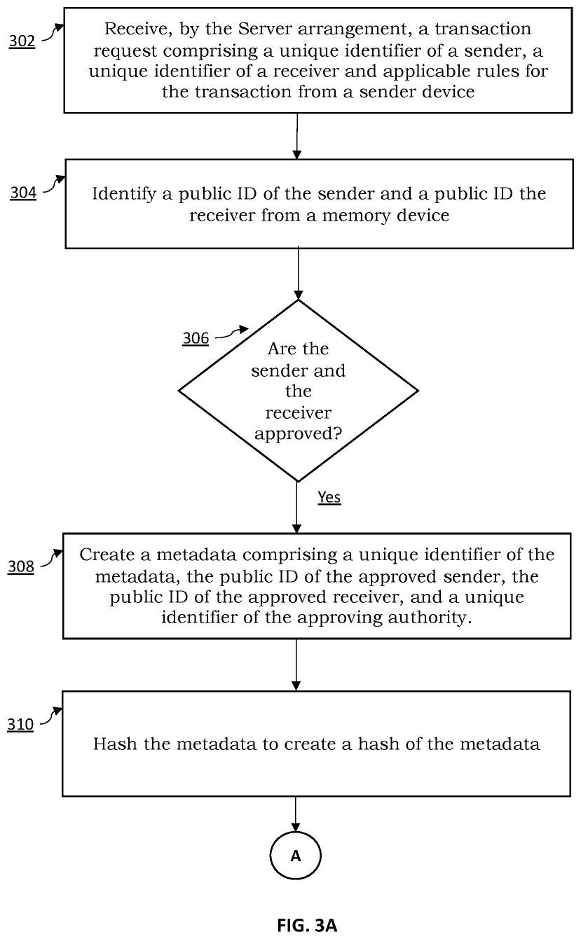

FIG. 2 depicts an exemplary embodiment of a metadata, an approved transaction token 200. The approved transaction token 200 includes a hash of the metadata 202 and a private key of the approving authority 204. The hash of metadata 202 may be metadata comprising a unique identifier of the metadata, the public ID of the approved sender, the public ID of the approved receiver and a unique identifier of the approving authority and is hashed using SHA-256 or 32-byte Keccak hash.

For every cryptocurrency transaction where the senders and the receivers are approved by the approving authority, an approved transaction token 200 may be created. The approved transaction token 200 comprises the at least one hash of the at least one metadata and a private key of the approving authority. This approved transaction token may be used as a proof of authenticity of the transaction. In alternate embodiments, the any third party may ask the approving authority to verify a transaction by providing the approved transaction token of the transaction. The approving authority crosschecks the provided approved transaction token with the actual approved transaction token created during the transaction and if it is a match, then the approving authority flags the transaction as authentic. In case the match of approving authority does not find the match, the approval is denied and the transaction is sealed until the verification process by the approving authority is completed and the KYC information is found to be authentic.

A distributed ledger-based platform may have a public ID for a user of the system which is known to all the other users of the system and a private ID which is known only to the user. The use of a private key ensures that the transaction has been initiated or approved by the user. Similarly, an approving authority may also have a public ID and a private ID. If the Private ID of the approving authority is present in the metadata of the transaction, it indicates that the transaction has been approved by the authentic approving authority and adds an additional layer of authenticity to the transactions.

In one or more embodiments, each transaction between the one or more sender devices 104 and the one or more receiver devices 106 are executed using one or more smart contracts. Smart contracts are self-executing agreements between parties that have all the terms and conditions written in code, and execute automatically, depending on future signatures or trigger events. By leveraging block chain technologies, smart contracts, once appended to the block chain, may not be revoked, denied, or reversed. Smart contracts usually provide multiple functions which may be executed by simply invoking a call method on the block chain to which the said smart contract is appended to.

The one or more transaction requests and the at least one approved transaction token 200 are added as a new block on to the blockchain and the one or more applicable transaction rules are added as the one or more smart contracts. Upon successful satisfaction of the one or more applicable transaction rules, the smart contract executes itself to complete the one or more transactions.

In an additional embodiment, the server arrangement 102 is further configured to send the at least one approved transaction token 200 to the one or more sender devices 104. The one or more sender devices 104 is configured to hash the received at least one approved transaction token, sign it using one or more private keys of the one or more senders and transfer the one or more transaction requests along with the hashed and signed at least one approved transaction token 200 to a distributed ledger-based platform 110. This embodiment presents an additional layer of security to the transactions being made at the user level.

In various other embodiments, de-centralized database may be a blockchain. In one of the embodiments, the system enables transaction of cryptocurrencies, wherein a sender requests for a transfer of some cryptocurrency to a receiver along with a predefined rule for the transaction. Bitcoins, Etherium, and Ripple are examples of such cryptocurrency. The system may use one or more of cryptocurrency. Alternatively, the system may be used for transaction of a new type of cryptocurrency. Further, in an embodiment of the present disclosure, the server arrangement 102 validates successful satisfaction of the predefined rules of the transaction. Upon successful satisfaction, the one or more smart contracts associated with the said transaction is executed to transfer the requested amount of cryptocurrency from a virtual wallet linked associated to the sender to a virtual wallet associated to receiver.

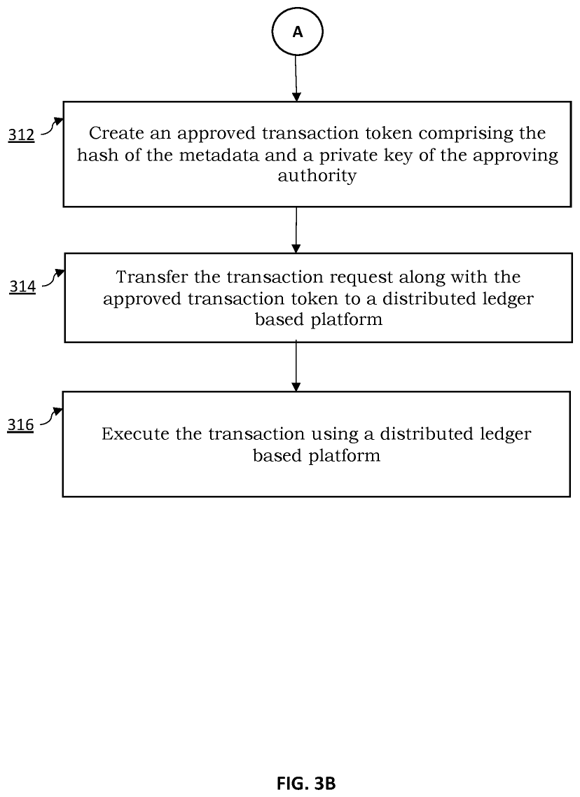

Referring to FIGS. 3A and 3B, flow charts depicting steps of a method of facilitating cryptocurrency transaction are illustrated. The method is depicted as a collection of steps in a logical flow diagram, which represents a sequence of steps that may be implemented in hardware, software, or a combination thereof, for example as aforementioned. The method is implemented via a system comprising a server arrangement 102 communicably coupled via one or more communication networks with a sender device 104, a receiver device 106, a distributed ledger-based platform 110, and a memory device.

At 302, a transaction request including a unique identifier of a sender, a unique identifier of a receiver and applicable rules for the transaction is received by the server arrangement 102 from the sender device 104.

At 304, a public ID of the sender and a public ID the receiver is identified from the memory device.

At 306, the sender and the receiver are checked if they are approved by an approving authority.

Upon successful check at step 306, at step 308, a metadata is created for each of the transactions, wherein the metadata comprises a unique identifier of the metadata, the public ID of the approved sender, the public ID of the approved receiver, and a unique identifier of the approving authority.

At step 310, the metadata is hashed and a hash of the metadata is created.

At step 312, an approved transaction token 200 is created for each of the hash of the metadata wherein the approved transaction token comprises the hash of the metadata and a private key of the approving authority.

At step 314, the server arrangement 102 transfers the transaction request along with the approved transaction token to a distributed ledger-based platform 110.

At step 316, the transaction is executed using the distributed ledger-based platform.

In other embodiments, an additional layer of security is added at the user level, wherein the method also includes the method steps comprising sending the at least one approved transaction token 200 to the one or more sender devices by server arrangement 102. The method further comprises hashing the received at least one approved transaction token 200 by the one or more sender devices, signing it using one or more private keys of the one or more senders and transferring the one or more transaction requests along with the hashed and signed at least one approved transaction token 200 to a distributed ledger-based platform 110.

In various embodiments, the system and method have a ledger that keeps track of all the transaction requests and status of the transactions. The system and method may further include a database wherein the public IDs of the senders and receivers, details of approval of the senders and receivers, KYC details of the approved senders and receivers are stored.

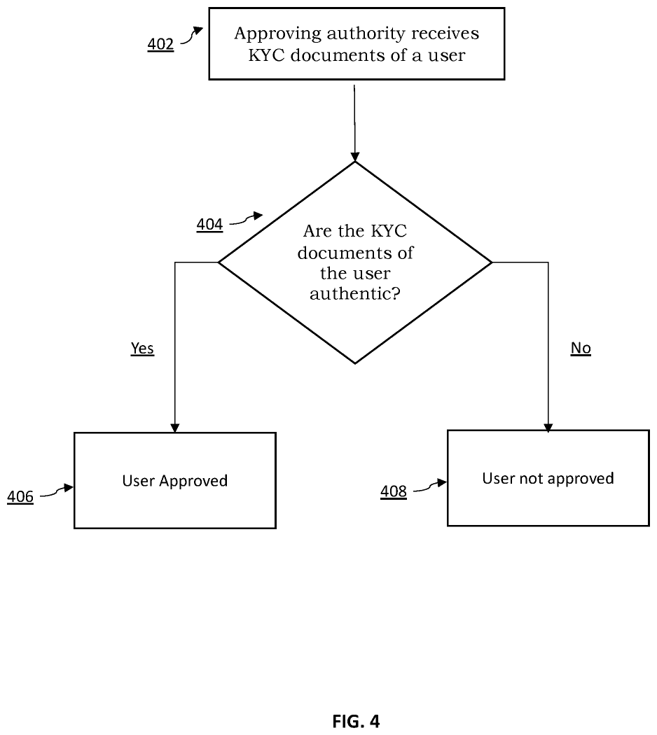

Referring now to FIG. 4, a flow chart depicting steps of a method for approving a user is illustrated.

At step 402, an approving authority receives KYC documents of a user from the user of the system 100, wherein the user may be a sender or a receiver in the system. The KYC documents may be one or more of approved valid original government ID proofs such as Social Security Card, Driving License, Passport, etc.

At step 404, the approving authority verifies the authenticity the KYC documents of the users. This is done either by traditional means of cross-checking with a central database or outsourcing thereto to a third party for verification. Further, verification of the authenticity the KYC documents may also be done with the help of computer software and AI.

At step 406, the approving authority approves the user as approved based on the successful verification of the authenticity of the KYC documents. If the KYC documents are not authentic, the user is not approved or denied at 408.

The system may further comprise a location tracking module, comprising of one or more sensors to track the location of the one or more senders and the one or more receivers. Without limiting the scope of the disclosure, the one or more sensors are GPS, inertial sensor and a Camera.

In an additional embodiment, the system and method may further be integrated with an existing system, which acts as payment gateway using cryptocurrency transactions, wherein it enables for the information of the transactions being available. In addition, the system and methods may also be used for automatic deduction of any taxes applicable for the transaction and fees applicable for the transaction to be automatically deducted while executing the transaction based on a set of conditions. Having the KYC details ensures and helps to deduct appropriate taxes and submit thereto to the concerned authorities. For illustration purposes, an income tax applicable as per the tax rates set by the government may be deducted while making the payment, wherein the transaction pertains to payment of salary.

It shall be appreciated by the person skilled in the art that such a system and method could be implemented to facilitate various alternate use cases as well. Without limiting the scope of the disclosure, one such use case is regarding revealing the identity of the sender or the receiver of a transaction in in case of a legal action (civil or criminal). Upon receiving a proper legal request (such as a warrant), the approving authority may reveal the information regarding the transaction and the sender and receiver associated with the transaction. This helps building the trust of the governments that if the cryptocurrency is used for fraud or any illegal purposes, both the sender and receiver may be deanonymized and prosecuted.

In another variation, the system may be used for combating money laundering. The immutable aspect (hash) of the metadata ensures all the information related to the transaction are available if need be. Thus, if need be, laundered money may be tracked.

Tax deductions may also be done as another variation. Tax deductions are a service that could be performed since the sender and the receivers and the amount of the transaction are known. A smart contract is deployed that deducts the applicable tax rates for each transaction. The amount deducted by the smart contract is held until the tax is due and at that point transferred to the respective government entity (e.g., IRS).

In another embodiment, the system provides fraud protection for the users. Since the approving authority needs to sign every request, the transaction may be flagged if such transaction seems suspicious and pause the transaction.

Blockchains are, by design, a back-linked list, which allow new blocks of information to be chained onto the latest block. There are no user accounts or controlling servers, so no single entity may revise the collective blockchain for their own advantage. Each time a change is made to a blockchain, it is an appended update, not a modification update, and such an update requires the full history of changes in order to validate any future proposed transaction. Each update to a blockchain should also be verified cryptographically, which typically requires a substantial amount of computer processing resources. This ensures the safety and security of the users of the system. Further, the use of metadata to add information related to the transaction allows the tracking of the users of the system and authenticate the transactions. Further, once authenticated, it may be added as a block on the blockchain and it may then be securely stored. Blockchain configurations provide secure storage for transactions which have been logged in a blockchain. The immutable structure of the blockchain is desirable for financial transactions which require various types of information for security purposes and with an additional level of information transparency, it provides a novel solution to track cryptocurrency transactions, tackles problems such as money laundering and other illegal activities and adds an additional layer of security.

It shall be further appreciated by the person skilled in the art that the terms “first”, “second” and the like herein do not denote any specific role or order or importance, but rather are used to distinguish one party from another.

Any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

Although an exemplary embodiment of at least one of a system and a method has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures may be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules may be sent between the modules via at least one of: a data network, the Internet, a voice network, an Internet Protocol network, a wireless device, a wired device and/or via plurality of protocols. Also, the data sent or received by any of the modules may be sent or received directly and/or via one or more of the other modules.

One skilled in the art will appreciate that a “system” could be embodied as a processor, a computer device integrated in a vehicle, a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

The description, embodiments and figures are not to be taken as limiting the scope of the claims. It should also be understood that throughout this disclosure, unless logically required to be otherwise, where a process or method is shown or described, the steps of the method may be performed in any order, repetitively, iteratively or simultaneously. At least portions of the functionalities or processes described herein may be implemented in suitable computer-executable instructions. It will be appreciated that features of the present disclosure are susceptible to being combined in various combinations and additional features may be introduced without departing from the scope of the present disclosure.

What is claimed is:

1. A system for facilitating secure cryptocurrency transaction, the system comprising:
a server arrangement communicably coupled via a communication network with one or more sender devices and one or more receiver devices, wherein the server arrangement is configured to:
receive one or more transaction requests for one or more cryptocurrency transactions from the one or more sender devices, wherein the one or more transaction requests comprises at least
a unique identifier of one or more senders, the one or more senders using the corresponding sending devices,
a unique identifier of one or more receivers, the one or more receivers using the corresponding receiving devices, and
one or more applicable rules for the transaction;
identify one or more public IDs of the one or more senders and one or more public IDs the one or more receivers from a memory device communicably coupled with the server arrangement;
identify whether or not, the one or more senders and the one or more receivers are approved by an approving authority;
create, based on the successful identification of the one or more senders and the one or more receivers as an approved, at least one metadata for each of the one or more transactions, wherein the at least one metadata comprises at least
a unique identifier of the at least one metadata,
the one or more public IDs of one or more approved senders,
the one or more public IDs of one or more approved receivers, and
a unique identifier of the approving authority;
create at least one hash of the at least one metadata;
create at least one approved transaction token for the at least one hash of the at least one metadata wherein the at least one approved transaction token comprises the at least one hash of the at least one metadata and a private key of the approving authority;
transfer the one or more transaction requests along with the at least one approved transaction token to a distributed ledger-based platform; and
execute the one or more transactions using the distributed ledger-based platform.

2. The system of claim 1, wherein the server arrangement is further configured to send the at least one approved transaction token to the one or more sender devices.

3. The system of claim 2, wherein the one or more sender devices is configured to hash the received at least one approved transaction token, sign it using one or more private keys of the one or more senders and transfer the one or more transaction requests along with the hashed and signed at least one approved transaction token to a distributed ledger-based platform.

4. The system of claim 1, wherein the one or more sender devices is configured to hash the received at least one approved transaction token, sign it using one or more private keys of the one or more senders and transfer the one or more transaction requests along with the hashed and signed at least one approved transaction token to a distributed ledger-based platform.

5. The system of claim 1, wherein the server arrangement is configured to facilitate, via an associated device, the approving authority to:
receive from the one or more senders and the one or more receivers, one or more Know your customer (KYC) documents of the one or more senders and the one or more receivers respectively;
verify if the received one or more KYC documents complies with at least one predefined authenticity criterion;
approve the one or more senders and the one or more receivers, in the event the received one or more KYC documents complies with at least one predefined authenticity criterion; and
deny approval to the one or more senders and the one or more receivers, in the event the received one or more KYC documents fails to comply with the at least one predefined authenticity criterion.

6. The system of claim 1, wherein the at least one approved transaction token is used to verify the authenticity of the one or more transactions, the one or more senders and the one or more receivers.

7. The system of claim 1, wherein the distributed ledger-based platform is a blockchain.

8. The system of claim 1, wherein the at least one metadata for each of the one or more transactions comprises one or more of a type of cryptocurrency to be used, a crypto exchange to be used for the transaction, one or more transaction amounts for each of the one or more transactions, a location of the one or more senders and the one or more receivers, a contact information of the one or more senders and the one or more receivers, crypto exchange rate.

9. The system of claim 1, wherein the transaction request and the at least one approved transaction token are added as a new block on the blockchain.

10. The system of claim 1, wherein the one or more transactions are executed using one or more smart contracts.

11. A method for facilitating secure cryptocurrency transaction, the method to be processed using a server arrangement, the method comprising:
receiving one or more transaction requests for one or more cryptocurrency transactions from the one or more sender devices, wherein the one or more transaction requests comprises at least
a unique identifier of one or more senders, the one or more senders using the corresponding sending devices,
a unique identifier of one or more receivers, the one or more receivers using the corresponding receiving devices, and
one or more applicable rules for the transaction;
identifying one or more public IDs of the one or more senders and one or more public IDs the one or more receivers from a memory device communicably coupled with the server arrangement;
identifying whether or not, the one or more senders and the one or more receivers are approved by an approving authority;
creating, based on the successful identification of the one or more senders and the one or more receivers as an approved, at least one metadata for each of the one or more transactions, wherein the at least one metadata comprises at least
a unique identifier of the at least one metadata,
the one or more public IDs of one or more approved senders,
the one or more public IDs of one or more approved receivers, and
a unique identifier of the approving authority;
creating at least one hash of the at least one metadata;
creating at least one approved transaction token for the at least one hash of the at least one metadata wherein the at least one approved transaction token comprises the at least one hash of the at least one metadata and a private key of the approving authority;
transferring the one or more transaction requests along with the at least one approved transaction token to a distributed ledger-based platform; and
executing the one or more transactions using the distributed ledger-based platform.

12. The method of claim 11, wherein the method comprises, sending the at least one approved transaction token to the one or more sender devices by server arrangement.

13. The method of claim 12 further comprising hashing the received at least one approved transaction token by the one or more sender devices, signing it using one or more private keys of the one or more senders and transferring the one or more transaction requests along with the hashed and signed at least one approved transaction token to a distributed ledger-based platform.

14. The method of claim 11 further comprising hashing the received at least one approved transaction token by the one or more sender devices, signing it using one or more private keys of the one or more senders and transferring the one or more transaction requests along with the hashed and signed at least one approved transaction token to a distributed ledger-based platform.

15. The method of claim 11 further comprising:
receiving, by the approving authority, via an associated device, from the one or more senders and the one or more receivers, one or more know your customer (KYC) documents of the one or more senders and the one or more receivers;
verifying if the received one or more KYC documents complies with at least one predefined authenticity criterion;
approving the one or more senders and the one or more receivers, in the event the received one or more KYC documents complies with at least one predefined authenticity criterion; and
denying approval to the one or more senders and the one or more receivers, in the event the received one or more KYC documents fails to comply with the at least one predefined authenticity criterion.

16. The method of claim 11, wherein the at least one approved transaction token is used to verify the authenticity of the one or more transactions, the one or more senders and the one or more receivers.

17. The method of claim 11, wherein the distributed ledger-based platform is a blockchain.

18. The method of claim 11, wherein the at least one metadata for each of the one or more transactions comprises one or more of a type of cryptocurrency to be used, a crypto exchange to be used for the transaction, one or more transaction amounts for each of the one or more transactions, a location of the one or more senders and the one or more receivers, a contact information of the one or more senders and the one or more receivers, crypto exchange rate.

19. The method of claim 11, wherein the transaction request and the at least one approved transaction token are added as a new block on the blockchain.

20. The method of claim 11, wherein the one or more transactions are executed using one or more smart contracts.
